(19) United States
(12) Patent Application Publication
(10) Pub. No.: US 2026/0331840 A1
(43) Pub. Date: Oct. 22, 2026

(54) SHIELDED CABLE AND CONNECTOR

(71) Applicant: SUMITOMO WIRING SYSTEMS, LTD., Mie (JP)

(72) Inventor: Takeshi MISU, Mie (JP)

(21) Appl. No.: 19/119,410

(22) PCT Filed: Sep. 28, 2023
(86) PCT No.: PCT/JP2023/035324

§ 371 Date: Apr. 9, 2025

(30) Foreign Application Priority Data
Oct. 18, 2022 (JP) 2022-166960

(51) Int. Cl. H01R 13/6592

(52) U.S. Cl. CPC H01R 13/6592

(57) ABSTRACT

A shielded cable (2) includes a shield member (12) for shielding noise on an outer peripheral surface of a cable member (21) to be electrically connected to a mating connector via an electrical terminal (14). The shielded cable (2) includes a tubular shield (15). The shield (15) includes a wire crimping portion (37) to be fixed to the shield member (12) by crimping and a shield connecting portion (38) for contacting a GND terminal of the mating connector when the electrical terminal (14) is electrically connected to the mating connector. The wire crimping portion (37) includes a slit (46) for absorbing deformation of the shield connecting portion (38) when the wire crimping portion (37) is crimped to the shield member (12).

### TECHNICAL FIELD

The present disclosure relates to a shielded cable and a connector.

### BACKGROUND

Conventionally, a shielded cable in which a hollow cylindrical metal shell is electrically connected to a wire braid is known as disclosed in Patent Document 1. The braid is exposed from a sheath covering an insulated core wire and that exposed part is folded. The metal shell is fixed to the braid by being crimped to the folded part of the braid.

### PRIOR ART DOCUMENT

### Patent Document

Patent Document 1: JP H08-250218 A

### SUMMARY OF THE INVENTION

### Problems to be Solved

When the shielded cable is attached to a connection destination, the tip of the metal shell on a side opposite to the part crimped to the braid is electrically connected to a GND terminal of the connection destination. When the metal shell is crimped and fixed to the braid, a crimp stress is transmitted to the tip side of the metal shell, whereby the tip of the metal shell is expanded radially outward, resulting in a possibility of being deformed into a conical shape. In this case, since a diameter of the tip of the metal shell is not that of an aimed shape, a connected state of the tip of the metal shell and the connection destination of the shielded cable may be hindered.

The present disclosure aims to provide a shielded cable and a connector enabling a shield to be satisfactorily connected to a mating connector.

### Means to Solve the Problem

A shielded cable solving the above problem is provided with a shield member for shielding noise on an outer peripheral surface of a cable member to be electrically connected to a mating connector via an electrical terminal, and a tubular shield including a wire crimping portion to be fixed to the shield member by crimping and a shield connecting portion for contacting a GND terminal of the mating connector when the electrical terminal is electrically connected to the mating connector, the wire crimping portion including a slit for absorbing deformation of the shield connecting portion when the wire crimping portion is crimped to the shield member.

A connector solving the above problem is provided with a shielded cable provided with a shield member for shielding noise on an outer peripheral surface of a cable member to be electrically connected to a mating connector via an electrical terminal, a connector housing to be attached to a connection destination of the shielded cable and a cap for covering the electrical terminal, the shielded cable including a tubular shield having a wire crimping portion to be fixed to the shield member by crimping and a shield connecting portion for contacting a GND terminal of the mating connector when the electrical terminal is electrically connected to the mating connector, and the wire crimping portion including a slit for absorbing deformation of the shield connecting portion when the wire crimping portion is crimped to the shield member.

### Effect of the Invention

According to the present disclosure, a shield can be satisfactorily connected to a mating connector.

### BRIEF DESCRIPTION OF THE DRAWINGS

FIG. 1 is a perspective view of a connector of one embodiment.

FIG. 2 is a schematic diagram showing a mating connector to be connected to the connector.

FIG. 3 is an exploded perspective view of an assembled cable.

FIG. 4 is an exploded perspective view of the connector

FIG. 5 is a section along V-V in FIG. 1.

FIG. 6 is a side view of a shield.

FIG. 7 is a back view of the shield.

FIG. 8 is a section along VIII-VIII in FIG. 1.

FIG. 9 is a perspective view of a cap when viewed from behind.

FIG. 10 is a side view in section showing a shielded cable before the shield is crimped.

FIG. 11 is a transverse section showing the shielded cable before the shield is crimped.

FIG. 12 is an enlarged side view in section showing the shape of a wire crimping portion after crimping.

### DETAILED DESCRIPTION TO EXECUTE THE INVENTION

First, embodiments of the present disclosure are listed and described.

[1] The shielded cable of the present disclosure is provided with a shield member for shielding noise on an outer peripheral surface of a cable member to be electrically connected to a mating connector via an electrical terminal, and a tubular shield including a wire crimping portion to be fixed to the shield member by crimping and a shield connecting portion for contacting a GND terminal of the mating connector when the electrical terminal is electrically connected to the mating connector, the wire crimping portion including a slit for absorbing deformation of the shield connecting portion when the wire crimping portion is crimped to the shield member.

According to the configuration of this example, unnecessary deformation of the shield by a crimping force can be allowed to escape into the slit when the wire crimping portion of the shield is crimped to the shield member of the shielded cable. That is, when the wire crimping portion is crimped, the deformation of the shield is absorbed by the slit, thereby making it possible to hardly transfer the deformation to other parts of the shield. In this way, the shield connecting portion of the shield is hardly deformed. Thus, in the shield, the shape of the shield connecting portion to be connected to the GND terminal of the mating connector can be maintained in an optimal shape. Therefore, the shield can be satisfactorily connected to the mating connector.

[2] In [1] described above, the slit is an oblique slit intersecting an axial direction of the shield. According to this configuration, the shield can be obliquely arranged with respect to a braid, for example, if the shield member is the braid. Thus, the braid can bite into the slit at the time of crimping. This contributes to improving a crimping force.

[3] In [1] or [2] described above, the slit is one of a plurality of slits, and the plurality of slits are respectively provided at positions different in a circumferential direction of the shield. According to this configuration, the shield can be deformed in a well-balanced manner when being crimped. This contributes to suppressing the deformation of the shield connecting portion.

[4] In any one of [1] to [3] described above, the shield connecting portion includes a leaf spring portion for contacting the GND terminal on an outer peripheral surface of the shield. According to this configuration, even if the shield is fixed to the shield member by crimping, the position of the leaf spring portion is hardly affected. Thus, the leaf spring portion can be brought into contact with the GND terminal with an optimal tension. This further contributes to satisfactorily connecting the shield to the mating connector.

[5] In any one of [1] to [4] described above, the shield member includes a folded portion formed by folding an end part of the shield member, and the wire crimping portion is crimped to the folded portion. According to this configuration, the shield can be fixed by being crimped to the folded portion of the shield member where crimping is easily performed.

[6] In [5] described above, the shielded cable is provided with a ring member for sandwiching and holding the folded portion together with the wire crimping portion inside the folded portion. According to this configuration, the shield can be tightly fixed to the shield member, using the ring member as a seat.

[7] In any one of [1] to [6] described above, the shield includes an engaging portion to be engaged with a connector housing so that the shield does not come out from the connector housing when the shield is mounted into the connector housing to be connected to the mating connector. According to this configuration, since the shield can be held in the connector housing by the engaging portion, it can be made difficult to detach the shield from the connector housing.

[8] In any one of [1] to [7] described above, the shield includes a positioning portion for positioning the shield in an insertion direction into a connector housing when the shield is mounted into the connector housing to be connected to the mating connector. According to this configuration, since the shield can be positioned in the insertion direction with respect to the connector housing, the shield can be arranged at an optimal mounted position.

[9] In any one of [1] to [8] described above, the electrical terminal includes a terminal body to be connected to a mating connector terminal of the mating connector and a terminal end portion fixed to the cable member, the terminal body is exposed to outside the shield, and the terminal end portion is accommodated inside the shield. According to this configuration, the shield can be formed into a short shape to cover only the periphery of an end part of the electrical terminal.

[10] The connector of the present disclosure is provided with a shielded cable provided with a shield member for shielding noise on an outer peripheral surface of a cable member to be electrically connected to a mating connector via an electrical terminal, a connector housing to be attached to a connection destination of the shielded cable and a cap for covering the electrical terminal, the shielded cable including a tubular shield having a wire crimping portion to be fixed to the shield member by crimping and a shield connecting portion for contacting a GND terminal of the mating connector when the electrical terminal is electrically connected to the mating connector, and the wire crimping portion including a slit for absorbing deformation of the shield connecting portion when the wire crimping portion is crimped to the shield member.

### DETAILS OF EMBODIMENT OF PRESENT DISCLOSURE

A specific example of the present disclosure is described with reference to the drawings. Note that the present invention is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from an actual one.

### (Wiring Harness 1)

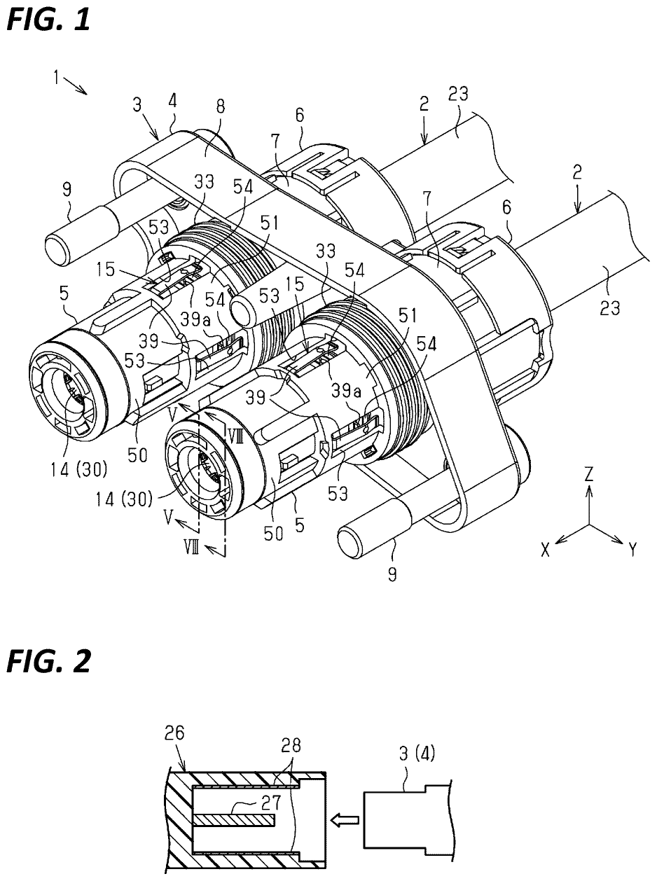

As shown in FIG. 1, a wiring harness 1 is provided with shielded cables 2 and a connector 3 for attaching the shielded cables 2 to a connection destination. The connector 3 is provided with a connector housing 4, caps 5 attached to the tips of the shielded cables 2 and covers 6 for covering the back surface of the connector housing 4. The connector housing 4 includes tube portions 7, into which the shielded cables 2 are inserted, and a plate-like portion 8 to be fixed to the connection destination. The plate-like portion 8 is fixed to the connection destination by a plurality of (two shown in FIG. 1) fasteners 9. The fasteners 9 are, for example, bolts.

In the case of this example, a plurality of the shielded cables 2 are provided side by side. A total of two shielded cables 2 are provided on a positive terminal side and a negative terminal side in this example. Note that since these shielded cables 2 have the same structure, only the shielded cable 2 on one side is described. The cap 5 and the cover 6 are provided for each shielded cable 2. The cap 5 is, for example, formed into a substantially hollow cylindrical shape. The cover 6 is so shaped that the shielded cable 2 is pulled out from the back surface of the tube portion 7 of the connector housing 4 while holding the shielded cable 2. The cover 6 is fixed to the connector housing 4, for example, by a locking structure.

### (Shielded Cable 2)

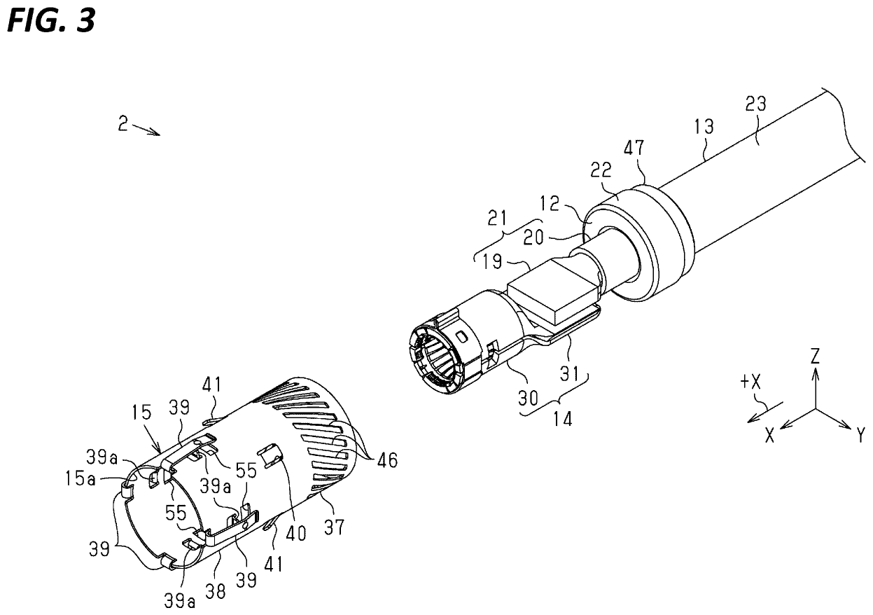

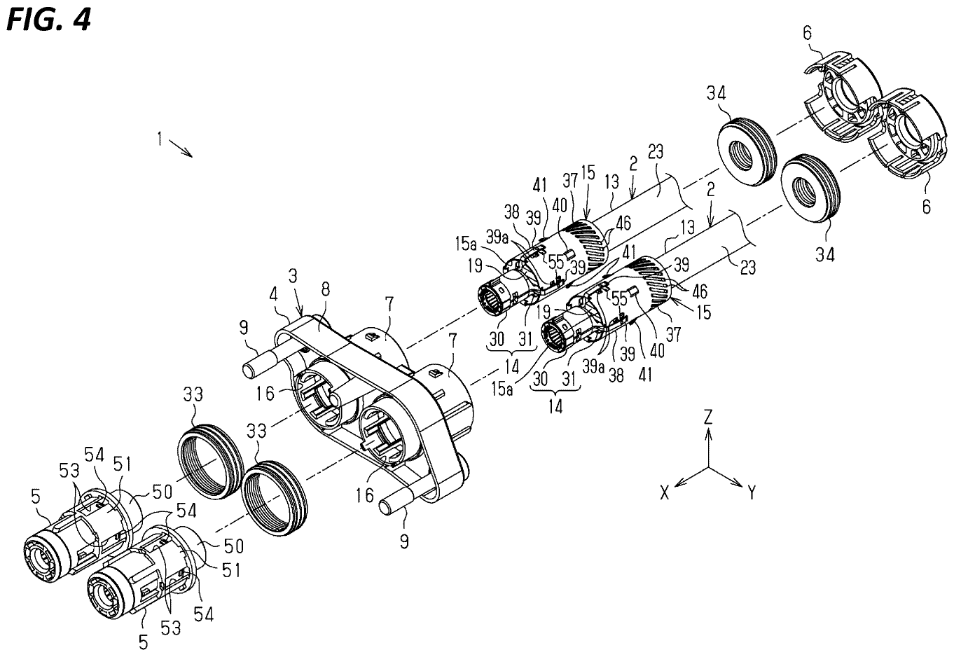

As shown in FIGS. 3 and 4, the shielded cable 2 is provided with a cable body 13 including a shield member 12 for shielding noise, an electrical terminal 14 mounted on the tip of the cable body 13 and a tubular shield 15 for connecting the shield member 12 to GND. The shielded cable 2 is mounted into the connector housing 4 by being inserted into a hole 16 (see FIG. 4) of the tube portion 7.

As shown in FIG. 3, the shielded cable 2 (cable body 13) is provided with a cable member 21 including a core wire 19 and an insulation coating 20. The cable member 21 includes, for example, the core wire 19 made of a conductor and the insulation coating 20 covering the outer periphery of the core wire 19. The cable member 21 is, for example, a high-voltage cable compatible with a high voltage and a large current.

The core wire 19 is, for example, a stranded wire formed by twisting a plurality of metal strands or a single-core wire constituted by one columnar metal bar having a solid internal structure. The core wire 19 may be a combination of a stranded wire and a plurality of types of conductors such as a single-core wire. A copper-based or aluminum-based metal material is, for example, used as a material of the core wire 19.

The insulation coating 20 covers, for example, the outer peripheral surface of the core wire 19 over an entire periphery. The insulation coating 20 is, for example, made of an insulating material such as synthetic resin. A synthetic resin mainly containing a polyolefin-based resin such as cross-linked polyethylene or cross-linked polypropylene is used as a material of the insulation coating 20. One type of material may be singly used or two or more types of materials may be used in appropriate combination as the material of the insulation coating 20.

The shield member 12 is, for example, a braid (braided wire) formed by bundling thin metal wires into a braid shape. The shield member 12 includes a folded portion 22 formed by folding the shield member 12 in an end part of the shield member 12. A covering member 23 for covering the cable member 21 from outside is provided on the outer peripheral surface of the shield member 12. The covering member 23 is, for example, a protective coating made of resin.

### (Mating Connector 26)

As shown in FIG. 2, the connector 3 (connector housing 4) is connected to a mating connector 26 as a connection destination of the wiring harness 1. The mating connector 26 is a female connector, for example, if the connector 3 is a male connector. The mating connector 26 includes mating connector terminals 27 to be connected to the electrical terminals 14. Grounded GND terminals 28 are provided inside the mating connector 26. The GND terminal 28 is, for example, a plate-like electrical contact point provided on the inner peripheral surface of the mating connector 26.

### (Shape of Electrical Terminal 14)

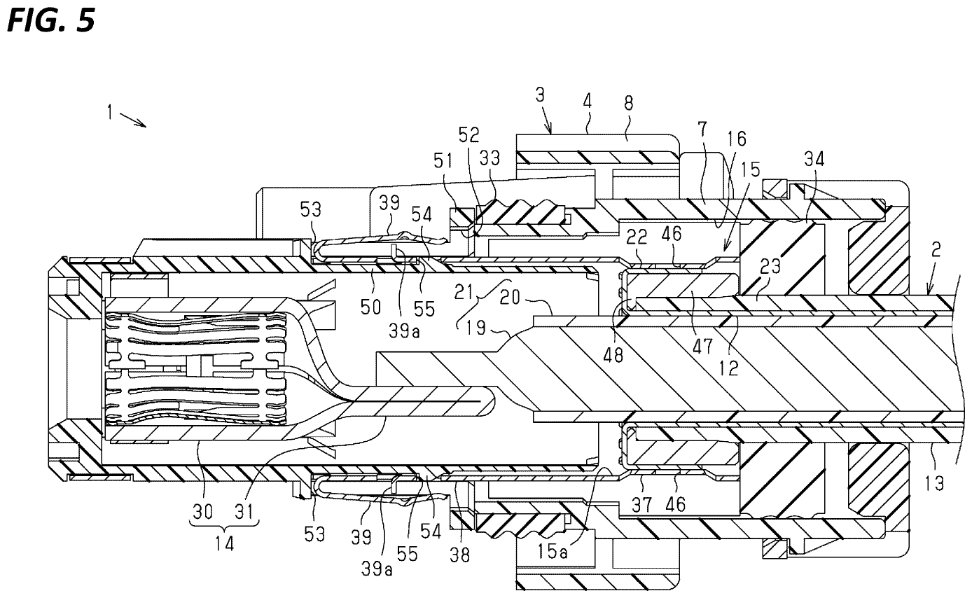

As shown in FIG. 5, the electrical terminal 14 includes a terminal body 30 to be connected to the mating connector terminal 27 of the mating connector 26 and a terminal end portion 31 fixed to the cable body 13. The terminal body 30 is exposed to outside the shield 15. The terminal end portion 31 is accommodated inside the shield 15. In the case of this example, the terminal body 30 is formed into a tubular shape and the terminal end portion 31 is formed into a flat plate shape in the electrical terminal 14. The electrical terminal 14 is accommodated into the cap 5 when the cap 5 is attached. In this way, the cap 5 covers the electrical terminal 14.

### (Sealing Structure of Connector 3)

As shown in FIGS. 4 and 5, a first sealing member 33 for sealing a gap between the connector housing 4 and the mating connector 26 is provided in the connector housing 4. The first sealing member 33 is, for example, a seal made of rubber. The first sealing member 33 is, for example, mounted on the outer periphery of a part of the tube portion 7, into which the cap 5 is inserted.

A second sealing member 34 is provided between the shielded cable 2 and the connector housing 4 to seal a gap between the shielded cable 2 and the connector housing 4. The second sealing member 34 is, for example, a seal made of rubber. The second sealing member 34 is, for example, arranged between the outer peripheral surface of the shielded cable 2 and the inner peripheral surface of the tube portion 7.

### (Shield 15)

As shown in FIGS. 3 to 6, the shield 15 includes a wire crimping portion 37 to be fixed to the shield member 12 by crimping and a shield connecting portion 38 for contacting the GND terminal 28 of the mating connector 26 when the electrical terminal 14 is electrically connected to the mating connector 26. The shield 15 is, for example, formed into a substantially hollow cylindrical shape and includes a hole 15a, through which the tip of the cable body 13 and the electrical terminal 14 are passed.

The shield connecting portion 38 includes leaf spring portions 39 for contacting the GND terminal 28 on the outer peripheral surface of the shield 15. A plurality (four in this example) of the leaf spring portions 39 are provided and arranged at equal intervals in a circumferential direction of the shield 15. The leaf spring portion 39 is, for example, formed into a cantilever shape and includes a contact point in the form of a circular protrusion for contacting the GND terminal 28. The shield 15 is formed with projections 39a capable of contacting the back surfaces of the leaf spring portions 39. The projection 39a is formed by cutting a part of the shield 15 and bending the cut part.

The shield 15 includes engaging portions 40 to be engaged with the connector housing 4 so that the shield 15 does not come out from the connector housing 4 when the shield 15 is mounted into the connector housing 4 to be connected to the mating connector 26. A plurality of (two in this example) the engaging portions 40 are provided on the outer peripheral surface of the shield 15. A pair of the engaging portions 40 are arranged to face each other in a diametrical direction of the shield 15. The engaging portion 40 is, for example, formed into a projection shape having a slope descending with respect to an insertion direction (+X axis direction shown in FIG. 3) of the shield 15 into the connector housing 4.

The shield 15 includes positioning portions 41 for positioning the shield 15 in the insertion direction (+X axis direction shown in FIG. 3) into the connector housing 4 when the shield 15 is mounted into the connector housing 4 to be connected to the mating connector 26. A plurality of (two in this example) the positioning portions 41 are provided on the outer peripheral surface of the shield 15. A pair of the positioning portions 41 are arranged to face each other in a diametrical direction of the shield 15. The positioning portion 41 is, for example, formed into a projection shape having a slope ascending with respect to the insertion direction (+X axis direction shown in FIG. 3) of the shield 15 into the connector housing 4.

As shown in FIG. 7, the plurality of leaf spring portions 39 are arranged at angles of 90° in the circumferential direction of the shield 15. The engaging portion 40 is arranged at a position separated by 45° in the circumferential direction of the shield 15 from the leaf spring portions 39 adjacently located in the circumferential direction. The positioning portion 41 is arranged at a position separated by 45° in the circumferential direction of the shield 15 from the leaf spring portions 39 adjacently located in the circumferential direction. The engaging portions 40 and the positioning portions 41 are alternately arranged at angles of 90° in the circumferential direction of the shield 15.

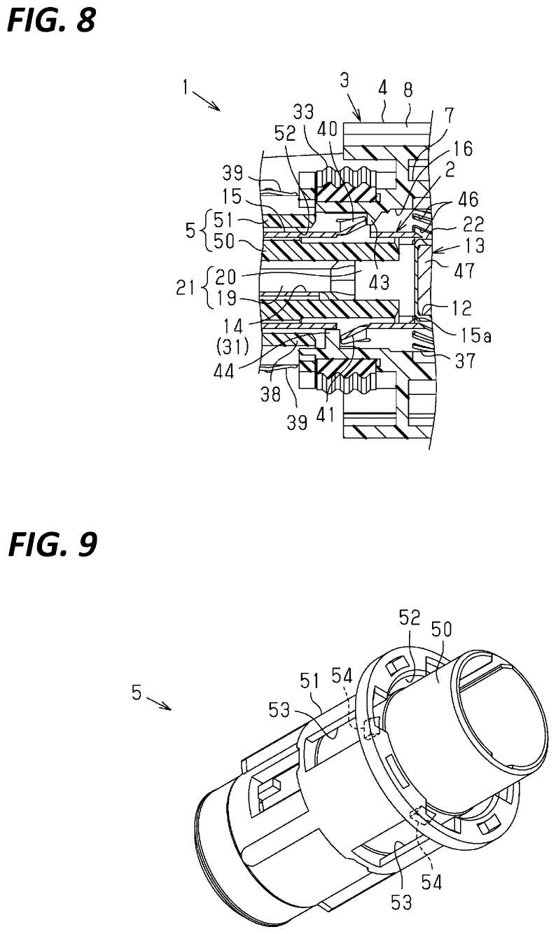

As shown in FIG. 8, the connector housing 4 is formed with protrusions 43 to be engaged with the engaging portions 40 of the shield 15. The protrusions 43 are, for example, formed on the inner peripheral surface of the hole 16 of the tube portion 7. By the engagement of the engaging portions 40 with the protrusions 43, the shield 15 is prevented from coming out from the connector housing 4. The connector housing 4 is formed with protrusions 44 to be engaged with the positioning portions 41 of the shield 15. The protrusions 44 are, for example, formed on the inner peripheral surface of the hole 16 of the tube portion 7. By the contact of the positioning portions 41 with the protrusions 44, a position when the shield 15 is inserted into the connector housing 4 is set.

### (Crimping Structure Using Slits 46)

As shown in FIGS. 3 to 7, the wire crimping portion 37 includes a plurality of slits 46 for absorbing the deformation of the shield connecting portion 38 when the wire crimping portion 37 is crimped to the shield member 12. In the case of this example, the shield 15 is fixed to the shield member 12, such as by crimping the wire crimping portion 37 to the shield member 12. The slits 46 are oblique slits 46 intersecting an axial direction of the shield 15 (X-axis direction in FIG. 3 and the like). The slits 46 are formed at a plurality of positions different in the circumferential direction of the shield 15. The wire crimping portion 37 is crimped to the folded portion 22.

As shown in FIGS. 3 and 5, the shielded cable 2 is provided with a ring member 47 serving as a seat when the shield 15 is crimped to the shield member 12. The ring member 47 is, for example, made of metal. A flange 48 (shown in FIG. 5) to be hooked to an end part of the covering member 23 is formed on the base end of the ring member 47. The ring member 47 is arranged inside the folded portion 22 on the outer peripheral surface of the covering member 23 of the shield member 12 and sandwiches and holds the folded portion 22 together with the wire crimping portion 37.

### (Functions of Cap 5)

As shown in FIG. 9, the cap 5 includes a cap body 50 for accommodating the electrical terminal 14 of the shielded cable 2 and an outer peripheral wall 51 arranged while being spaced apart from the cap body 50 by a predetermined distance. The cap body 50 is, for example, formed into a hollow cylindrical shape. The outer peripheral wall 51 is circumferentially formed around the cap body 50. The shield 15 is inserted into a gap 52 between the cap body 50 and the outer peripheral wall 51 when being mounted into the connector housing 4.

As shown in FIG. 5, the outer peripheral wall 51 of the cap 5 is formed with holes 53 for exposing the leaf spring portions 39 of the mounted shield 15 to outside. Projections 54 to be engaged with the shield 15 are formed on the outer peripheral surface of the cap body 50. The shield 15 is formed with recesses 55 to be engaged with the projections 54. The recesses 55 are, for example, through holes. The cap body 50 is arranged between the electrical terminal 14 and the shield 15 when the cap 5 is attached to the shield 15, thereby insulating the electrical terminal 14 and the shield 15.

### Functions of Embodiment

Next, functions of the connector 3 of this embodiment are described.

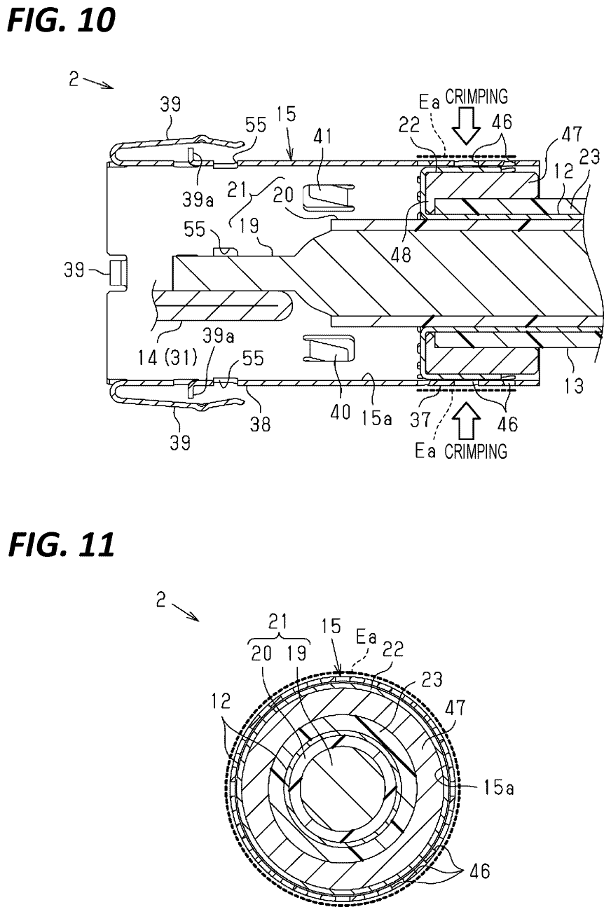

As shown in FIGS. 10 and 11, the shield 15 is first fixed to the cable body 13 by crimping. In the case of this example, the wire crimping portion 37 is crimped by sandwiching and crimping the periphery (crimping region Ea indicated by a dotted line in FIGS. 10 and 11) of the wire crimping portion 37 (including the slits 46) by a die. Crimping using a press die is, for example, used to crimp the wire crimping portion 37.

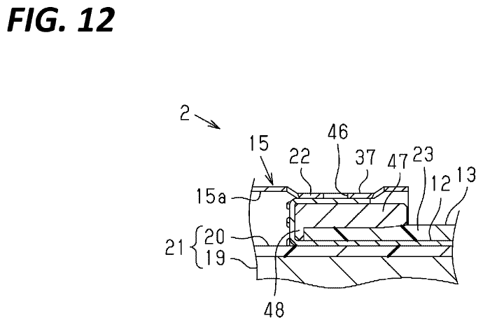

If the wire crimping portion 37 is crimped as shown in FIG. 12, the wire crimping portion 37 is concavely deformed by being crimped by that crimping force. At this time, unnecessary deformation of the shield 15 by the crimping force is allowed to escape into the slits 46. In this way, when the wire crimping portion 37 is crimped, the deformation of the shield 15 is absorbed by the slits 46, thereby making it possible to hardly transfer the deformation to other parts of the shield 15. In this way, the shield connecting portion 38 of the shield 15 is hardly deformed. Thus, the shape of the shield connecting portion 38 can be maintained in an optimal shape. Therefore, the shield 15 can be satisfactorily connected to the mating connector 26.

After the shielded cable 2 is fabricated by mounting the shield 15 on the cable body 13, this shielded cable 2 is mounted into the connector housing 4. Specifically, the shielded cable 2 is inserted into the hole 16 of the connector housing 4. The shielded cable 2 is inserted until the positioning portions 41 contact the protrusions 44 of the connector housing 4. Further, when the shielded cable 2 is inserted to the back of the hole 16, the engaging portions 40 are hooked to the protrusions 43 to be retained. In this way, the shield 15, i.e. the shielded cable 2, is fixed to the connector housing 4.

Subsequently, the cap 5 is attached to the shielded cable 2 mounted into the connector housing 4. At this time, the cap 5 is attached to the shielded cable 2 to insert the shield 15 into the gap 52. The shield 15 is inserted until the projections 54 of the cap 5 are engaged with the recesses 55 of the shield 15 while the leaf spring portions 39 of the shield 15 are located in the holes 53 of the cap 5. In the above way, the connector 3 is assembled.

### Effects of Embodiment

According to the connector 3 of this embodiment, the following effects can be achieved.

(1) The shielded cable 2 is provided with the shield member 12 for shielding noise on the outer peripheral surface of the cable member 21 to be electrically connected to the mating connector 26 via the electrical terminal 14. The shielded cable 2 is provided with the tubular shield 15. The shield 15 includes the wire crimping portion 37 to be fixed to the shield member 12 by crimping and the shield connecting portion 38 for contacting the GND terminal 28 of the mating connector 26 when the electrical terminal 14 is electrically connected to the mating connector 26. The wire crimping portion 37 includes the slits 46 for absorbing the deformation of the shield connecting portion 38 when the wire crimping portion 37 is crimped to the shield member 12.

According to the configuration of this example, when the wire crimping portion 37 of the shield 15 is crimped to the shield member 12 of the shielded cable 2, unnecessary deformation of the shield 15 by a crimping force can be allowed to escape into the slits 46. That is, when the wire crimping portion 37 is crimped, the deformation of the shield 15 is absorbed by the slits 46, thereby making it possible to hardly transfer the deformation to other parts of the shield 15. In this way, the shield connecting portion 38 of the shield 15 is hardly deformed. Thus, in the shield 15, the shape of the shield connecting portion 38 to be connected to the GND terminal 28 of the mating connector 26 can be maintained in an optimal shape. Therefore, the shield 15 can be satisfactorily connected to the mating connector 26.

(2) The slits 46 are oblique slits intersecting the axial direction of the shield 15. According to this configuration, the slits 46 can be obliquely arranged with respect to a braid, for example, if the shield member 12 is the braid. Thus, the braid can bite into the slits at the time of crimping. This contributes to improving a crimping force.

(3) The plurality of slits 46 are respectively formed at the positions different in the circumferential direction of the shield 15. According to this configuration, the shield 15 can be deformed in a well-balanced manner when being crimped. This contributes to suppressing the deformation of the shield connecting portion 38.

(4) The shield connecting portion 38 includes the leaf spring portions 39 for contacting the GND terminal 28 on the outer peripheral surface of the shield 15. According to this configuration, even if the shield 15 is fixed to the shield member 12 by crimping, the positions of the leaf spring portions 39 are hardly affected. Thus, the leaf spring portions 39 can be brought into contact with the GND terminal 28 with an optimal tension. This further contributes to satisfactorily connecting the shield 15 to the mating connector 26.

(5) The shield member 12 includes the folded portion 22 formed by folding the end part of the shield member 12. The wire crimping portion 37 of the shield 15 is crimped to the folded portion 22 of the shield member 12. According to this configuration, the shield 15 can be crimped and fixed to the folded portion 22 of the shield member 12 where crimping is easily performed.

(6) The shielded cable 2 is provided with the ring member 47 arranged inside the folded portion 22. The ring member 47 sandwiches and holds the folded portion 22 together with the wire crimping portion 37. According to this configuration, the shield 15 can be tightly fixed to the shield member 12, using the ring member 47 as a seat.

(7) The shield 15 includes the engaging portions 40 to be engaged with the connector housing 4 so that the shield 15 does not come out from the connector housing 4 when the shield 15 is mounted into the connector housing 4 to be connected to the mating connector 26. According to this configuration, since the shield 15 can be held in the connector housing 4 by the engaging portions 40, the shield 15 can be made difficult to detach from the connector housing 4.

(8) The shield 15 includes the positioning portions 41 for positioning the shield 15 in the insertion direction into the connector housing 4 when the shield 15 is mounted into the connector housing 4 to be connected to the mating connector 26. According to this configuration, since the shield 15 can be positioned in the insertion direction with respect to the connector housing 4, the shield 15 can be arranged at an optimal mounting position.

(9) The electrical terminal 14 includes the terminal body 30 to be connected to the mating connector terminal 27 of the mating connector 26 and the terminal end portion 31 fixed to the cable member 21. The terminal body 30 is exposed to outside the shield 15. The terminal end portion 31 is accommodated inside the shield 15. According to this configuration, the shield 15 can be formed into a short shape to cover only the periphery of an end part of the electrical terminal 14.

### Other Embodiments

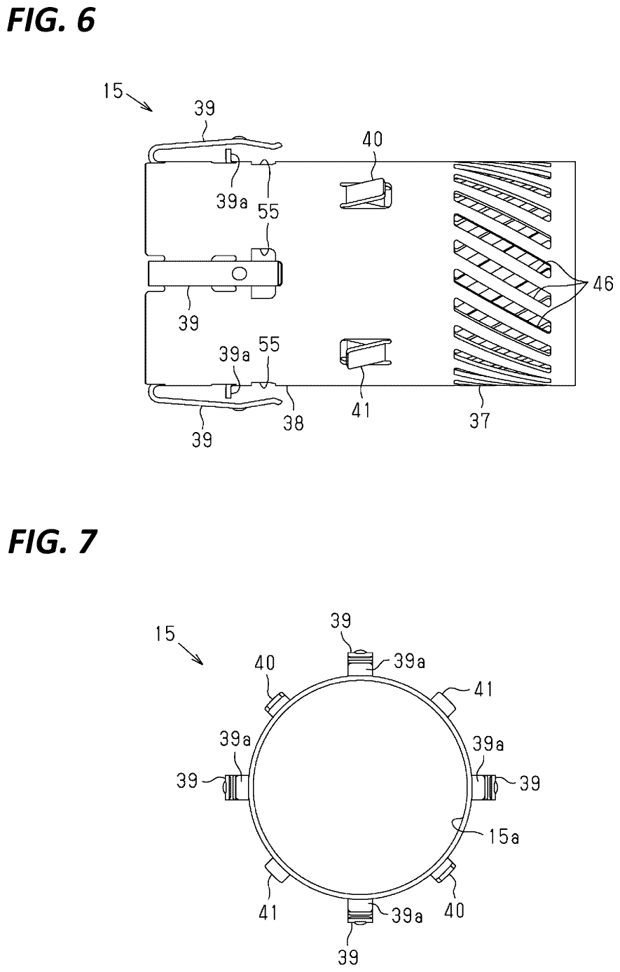

Note that the above embodiment can be modified and carried out as follows. The above embodiment and the following modifications can be carried out in combination without technically contradicting each other.
The shield member 12 is not limited to a braid and, for example, another member such as a pipe member (pipe shield) may be used.
The slit 46 is not limited to an elongated hole and may be, for example, a polygonal hole or a circular (elliptical) hole. Further, the slit 46 may be a hole having a designed shape and may have a logo mark shape, a symbol shape or a predetermined geometric shape.
The slit 46 may be configured by combining different slit shapes.
The shield 15 may include only one slit 46.
The electrical terminal 14 may be entirely located inside the shield 15.
The leaf spring portion 39 is not limited to a cantilevered spring and may be, for example, changed to another type of spring such as a disc spring or a spiral spring.
Only one leaf spring portion 39 may be provided.
The shapes of the engaging portions 40 and the positioning portions 41 can be changed to various shapes if the engaging portions 40 and the positioning portions 41 can be engaged with the connector 3 (connector housing 4). Further, the numbers and arranged positions of the engaging portions 40 and the positioning portions 41 are not limited to those in the embodiment and may be changed as appropriate.
The connector 3 is not limited to the one for vehicle and may be used in another device or apparatus.
In the shown embodiment, the shield 15 may be configured such that only the wire crimping portion 37 is plastically deformable in the shield 15 by the plurality of slits 46 when the wire crimping portion 37 is crimped.
As shown in FIG. 6, the plurality of slits 46 may be parallel to each other in the circumferential direction of the shield 15.
As shown in FIGS. 6 and 11, the plurality of slits 46 may be separated at a constant or equal distance in the circumferential direction of the shield 15.
As shown in FIG. 11, the plurality of slits 46 may be provided over the entire periphery of the shield 15 in the circumferential direction.
The slits 46 of the shown embodiment may be defined by a plurality of metal bridges plastically deformable radially inward and/or in the circumferential direction. Both ends in a length direction of each slit 46 may be closed by the metal material of the tubular shield 15 so that each slit 46 does not communicate with the opening end of the tubular shield 15. For example, as in the shown embodiment, one ends of the plurality of metal bridges defining the plurality of slits 46 may be coupled by a looped metal strip defining the opening end of the tubular shield 15.
Although the present disclosure has been described with respect to the embodiment, the present disclosure is understood not to be limited to the embodiment and structures. The present disclosure also encompasses various modifications and modifications within the scope of equivalents. In addition, various combinations and forms, further other combinations and forms including only one element, more elements or less elements are also within the scope of the present disclosure and within the scope of thoughts.

### LIST OF REFERENCE NUMERALS

| | |
|---|---|
| 1 | wiring harness |
| 2 | shielded cable |
| 3 | connector |
| 4 | connector housing |
| 5 | cap |
| 6 | cover |
| 7 | tube portion |
| 8 | plate-like portion |
| 9 | fastener |
| 12 | shield member |
| 13 | cable body |
| 14 | electrical terminal |
| 15 | shield |
| 15a | hole |
| 16 | hole |
| 19 | core wire |
| 20 | insulation coating |
| 21 | cable member |
| 22 | folded portion |
| 23 | covering member |
| 26 | mating connector |
| 27 | mating connector terminal |
| 28 | GND terminal |
| 30 | terminal body |
| 31 | terminal end portion |
| 33 | first sealing member |
| 34 | second sealing member |
| 37 | wire crimping portion |
| 38 | shield connecting portion |
| 39 | leaf spring portion |
| 39a | projection |
| 40 | engaging portion |
| 41 | positioning portion |
| 43 | protrusion |
| 44 | protrusion |
| 46 | slit |
| 47 | ring member |
| 48 | flange |
| 50 | cap body |
| 51 | outer peripheral wall |
| 52 | gap |
| 53 | hole |
| 54 | projection |
| 55 | recess |

1. A shielded cable provided with a shield member for shielding noise on an outer peripheral surface of a cable member to be electrically connected to a mating connector via an electrical terminal, comprising:
a tubular shield including a wire crimping portion to be fixed to the shield member by crimping and a shield connecting portion for contacting a GND terminal of the mating connector when the electrical terminal is electrically connected to the mating connector,
the wire crimping portion including a slit for absorbing deformation of the shield connecting portion when the wire crimping portion is crimped to the shield member.

2. The shielded cable according to claim 1, wherein the slit is an oblique slit intersecting an axial direction of the shield.

3. The shielded cable according to claim 1, wherein:
the slit is one of a plurality of slits, and
the plurality of slits are respectively provided at positions different in a circumferential direction of the shield.

4. The shielded cable according to claim 1, wherein the shield connecting portion includes a leaf spring portion for contacting the GND terminal on an outer peripheral surface of the shield.

5. The shielded cable according to claim 1, wherein:
the shield member includes a folded portion formed by folding an end part of the shield member, and
the wire crimping portion is crimped to the folded portion.

6. The shielded cable according to claim 5, comprising a ring member for sandwiching and holding the folded portion together with the wire crimping portion by being arranged inside the folded portion.

7. The shielded cable according to claim 1, wherein the shield includes an engaging portion to be engaged with a connector housing so that the shield does not come out from the connector housing when the shield is mounted into the connector housing to be connected to the mating connector.

8. The shielded cable according to claim 1, wherein the shield includes a positioning portion for positioning the shield in an insertion direction into a connector housing when the shield is mounted into the connector housing to be connected to the mating connector.

9. The shielded cable according to claim 1, wherein:
the electrical terminal includes a terminal body to be connected to a mating connector terminal of the mating connector and a terminal end portion fixed to the cable member,
the terminal body is exposed to outside the shield, and
the terminal end portion is accommodated inside the shield.

10. A connector, comprising:
a shielded cable provided with a shield member for shielding noise on an outer peripheral surface of a cable member to be electrically connected to a mating connector via an electrical terminal;
a connector housing to be attached to a connection destination of the shielded cable; and
a cap for covering the electrical terminal,
the shielded cable including a tubular shield having a wire crimping portion to be fixed to the shield member by crimping and a shield connecting portion for contacting a GND terminal of the mating connector when the electrical terminal is electrically connected to the mating connector, and
the wire crimping portion including a slit for absorbing deformation of the shield connecting portion when the wire crimping portion is crimped to the shield member.
